(19) United States
(12) Patent Application Publication
(10) Pub. No.: US 2026/0098394 A1
(43) Pub. Date: Apr. 9, 2026

(54) FOLDABLE ASSEMBLY

(71) Applicant: Deere & Company, Moline, IL (US)

(72) Inventors: Brett S. Graham, Dubuque, IA (US); Mark A. Simon, Dubuque, IA (US); Arun Narayanan, Pune (IN); Sagar Nilajkar, Pune (IN)

(21) Appl. No.: 18/909,302

(22) Filed: Oct. 8, 2024

(51) Int. Cl. E02F 3/76; E02F 3/815

(52) U.S. Cl. CPC E02F 3/7672; E02F 3/8152

(57) ABSTRACT

Disclosed herein are example box blade assemblies and foldable assemblies for use with the same. The foldable assemblies can have two or more segments which are pivotally connected to each other, such that the assemblies can be moved between an unfolded configuration and a folded configuration. In some cases, the foldable assemblies can include an actuator configured to extend and retract to move the assemblies between the unfolded configuration and the folded configuration. A locking mechanism may also be included to lock the foldable assemblies in the unfolded configuration, and in some cases, to lock the actuator into an extended position. The locking mechanism may also be engaged by the actuator. The actuator may be in communication with a controller that allows the user of a work vehicle to control the operation of the actuator and thus the foldable assembly.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD

The present disclosure concerns foldable, actuated assemblies for use with box blades. Also disclosed herein are controllers for controlling the operation of the same.

### BACKGROUND

Box blades are tools for fine grading of ground surfaces, and generally comprise a straight blade contained within a box structure. To stabilize and guide the box blade, box blade assemblies typically include an arm, which may be positioned above the box blade, and a ground engagement feature such as a wheel at the end of the arm that contacts the ground. However, to allow the box blade to be used in tight spaces, such as close to a wall, it is desirable that the arm be foldable, such that a front portion of the arm can be lifted up and out of the way of the box blade.

Conventionally, this folding of the arm is done by a vehicle operator who has to leave the vehicle cab and manually lift and lock the arm into the folded configuration. However, in practice, this requires the operator to enter and exit the cab multiple times in a grading operation, as the arm must be lifted every time the operation approaches a tight space, and lowered when the operation leaves the tight space.

What is needed, then, is a foldable arm assembly for use with a box blade that may be conveniently raised and lowered. What is additionally needed is a foldable arm which remains substantially straight when lowered.

### BRIEF SUMMARY

Disclosed herein are examples of foldable assemblies, such as may be used with box blades in a work vehicle attachment. The foldable assemblies disclosed herein generally comprise a first section and a second section connected by a hinge that allows the first section to move pivotally relative to the first section to move the foldable assembly between a folded configuration and an unfolded configuration. In some examples, the foldable assemblies also comprise a locking mechanism, having a first bracket and a second bracket mounted, respectively, to the first section and the second section of the foldable assembly. The locking mechanism may be engaged to retain the foldable assembly in the unfolded configuration and disengaged to allow the foldable assembly to return to the folded configuration. In some examples, the foldable assembly and the locking mechanism may both be connected to one or more actuators that move the foldable assembly between the folded configuration and the unfolded configuration, and that engage and disengage the locking mechanism.

Certain examples concern a box blade assembly for a work vehicle. The box blade assembly comprises a frame member, a box blade extending from the frame member, a foldable arm extending from the frame member and positioned above the box blade, the foldable arm having a first segment mounted to the frame member at a proximal end of the first segment, a second segment extending from a distal end of the first segment, and a pivotal connector positioned between the first segment and the second segment, so as to allow the foldable arm to move between a folded configuration and an unfolded configuration, and an actuator extending between the first segment and the second segment of the foldable arm and movable between an extended position and a retracted position. Moving the actuator between extended position and the retracted position folds or unfolds the foldable arm.

Certain examples concern a foldable hydraulic assembly. The foldable hydraulic assembly comprises a foldable arm having a first segment, a second segment, and a pivotal connector connecting the first segment to the second segment such that the second segment is movable between a folded configuration and an unfolded configuration and a hydraulic cylinder extending between the first segment and the second segment of the foldable arm and configured to move between a retracted position, an extended position, and a locked position. The foldable hydraulic assembly also comprises a ground engaging feature attached to an end portion of the second segment of the foldable arm opposite to the pivotal connector and a locking mechanism operatively coupled to the hydraulic cylinder and configured to move between a disengaged position and an engaged position. Moving the hydraulic cylinder from the retracted position to the extended position moves the foldable arm from the folded configuration to the unfolded configuration. Moving the hydraulic cylinder from the extended position to the locked position moves the locking mechanism from the disengaged position to the engaged position. When the locking mechanism is in the engaged position, the second segment of the foldable arm is fixed relative to the first segment of the foldable arm.

Certain examples concern a method for remotely deploying a locking hydraulic arm of a work vehicle. The method comprises transmitting a control signal to drive a hydraulic cylinder, extending the hydraulic cylinder from a retracted position to an extended position in response to the control signal to move the locking hydraulic arm from a folded configuration to an unfolded configuration, and engaging a locking mechanism to prevent the locking hydraulic arm from returning to the folded configuration from the unfolded configuration. The locking mechanism is operatively connected to the hydraulic cylinder, such that locking mechanism is automatically engaged by the extending of the hydraulic cylinder after the locking hydraulic arm reaches the unfolded configuration.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view of a work machine and a foldable assembly according to one aspect of the present disclosure.

FIG. 2 is a side view of the foldable assembly of FIG. 1 in an unfolded configuration.

FIG. 3 is a side view of the foldable assembly of FIG. 1 in a locked configuration.

FIG. 4 is a side view of the foldable assembly of FIG. 1 in a folded configuration.00

FIG. 5 is a perspective view of the foldable assembly of FIG. 1.

FIG. 6 is a diagram of a controller according to one aspect of the present disclosure.

### DETAILED DESCRIPTION OF THE INVENTION

### General Terms

The following explanations of terms are provided to better describe the present disclosure and to guide those of ordinary skill in the art in the practice of the present disclosure. As used herein, "comprising" means "including" and the singular forms "a" or "an" or "the" include plural references unless the context clearly dictates otherwise. The term "or" refers to a single element of stated alternative elements or a combination of two or more elements, unless the context clearly indicates otherwise.

As used herein, the terms proximal and distal refer to direction along an attached object having a free end, relative to the point of attachment. Particularly, when an object is attached at one end, the end of the attachment is the proximal end, and the free end is the distal end. The direction along the object towards the point of attachment is the proximal direction. The direction along the object towards the free end is the distal direction.

Unless explained otherwise, all technical and scientific terms used herein have the same meaning as commonly understood to one of ordinary skill in the art to which this disclosure belongs. Although methods and compounds similar or equivalent to those described herein can be used in the practice or testing of the present disclosure, suitable methods and compounds are described below. The compounds, methods, and examples are illustrative only and not intended to be limiting, unless otherwise indicated. Other features of the disclosure are apparent from the following detailed description and the claims.

Unless otherwise indicated, all numbers expressing quantities of components, percentages, temperatures, times, and so forth, as used in the specification or claims are to be understood as being modified by the term "about." Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word "about" is recited. Furthermore, not all alternatives recited herein are equivalents.

### Introduction to the Disclosed Technology

The present disclosure concerns foldable assemblies for use with a work vehicle, and particularly concerns box blade assemblies including a foldable arm. Generally, such box blade assemblies comprise a box blade and a foldable arm, which can be positioned above the box blade. The foldable arm generally comprises at least two segments connected by a pivotal joint. The first segment is mounted to a structural member, and the second segment is mounted to the distal end of the first segment by the pivotal joint. A ground engaging feature can be positioned at the distal end of the second segment.

According to some aspects of the present disclosure, an actuator can be attached to the foldable assembly to move the foldable assembly between a folded configuration and an unfolded configuration. The foldable assembly may also comprise a locking mechanism configured to secure the foldable assembly in the unfolded configuration. In some cases, the locking mechanism is attached to the actuator.

In some cases, the actuator connected to the foldable arm may be controlled by a controller, configured to receive signals from a vehicle operator or a remote user. Thus, the foldable arm can be folded or unfolded and the locking mechanism engaged or disengaged by a remote user or a user within the cab of a work vehicle.

### Aspects of the Disclosed Technology

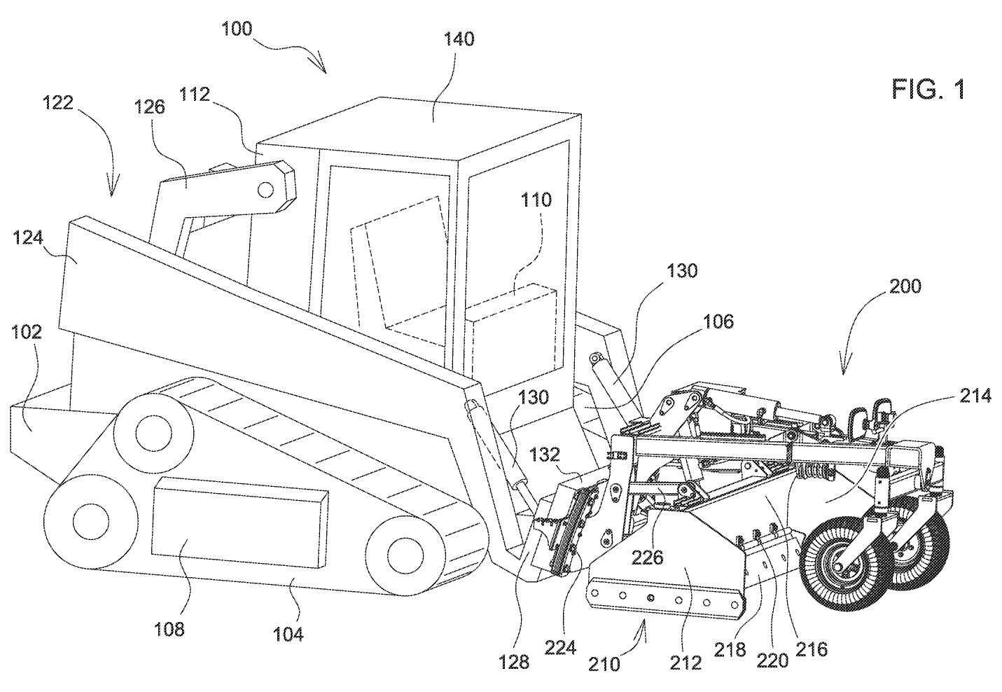

Referring now to the drawings, FIG. 1 depicts a work vehicle 100. According to one aspect of the present disclosure, the work vehicle 100 can be a vehicle such as the skid steer shown in FIG. 1.

The work vehicle 100 includes an undercarriage 102 having first and second ground engaging units 104 and 106 (for example, crawler tracks) including first and second hydraulic travel motors 108 for driving the first and second ground engaging units 104 and 106, respectively. As seen in FIG. 1, a main frame 112 is supported by the undercarriage 102. According to some aspects of the present disclosure, the first and second ground engaging units 104 and 106 may be left and right crawler tracks, respectively, as shown in FIG. 1.

According to one aspect of the present disclosure, the work vehicle 100 includes a working assembly 122 extending alongside and forward from the main frame 112. The working assembly 122 includes a main arm 124 and a pivot arm 126 pivotally connected to the main arm 124, and to the main frame 112. The working assembly 122 also includes a working tool mount 128 positioned at a front end of the main arm 124. In some examples, the working tool mount 128 can be pivotally connected to the main arm 124. In such examples, the working assembly 122 can also include one or more hydraulic actuators 130 disposed between the working tool mount 128 and the main arm 124. The one or more hydraulic actuators 130 can, in such examples, control the pivotal movement of the working tool mount 128 relative to the main arm 124.

According to one aspect of the present disclosure, the working tool mount 128 can be configured to receive one or more working tools, such as the foldable arm or the box blade disclosed in greater detail herein. The one or more working tools can be attached to the working tool mount 128 at a mounting plate 132, for example by one or more bolts that secure the working tool to the mounting plate 132 as shown in FIG. 1 and discussed in greater detail below. In some examples, the working tool mount 128 can also include a hydraulic linkage, which allows one or more hydraulic features of the one or more working tools to be driven from a hydraulic loop of the work vehicle 100.

A operator cab 140 may be located on the main frame 112, as illustrated in FIG. 1. The operator cab 140 and the working assembly 122 may both be mounted on the main frame so that the operator cab 140 faces in a working direction of the boom assembly. A control station 110 may be located in the operator cab 140.

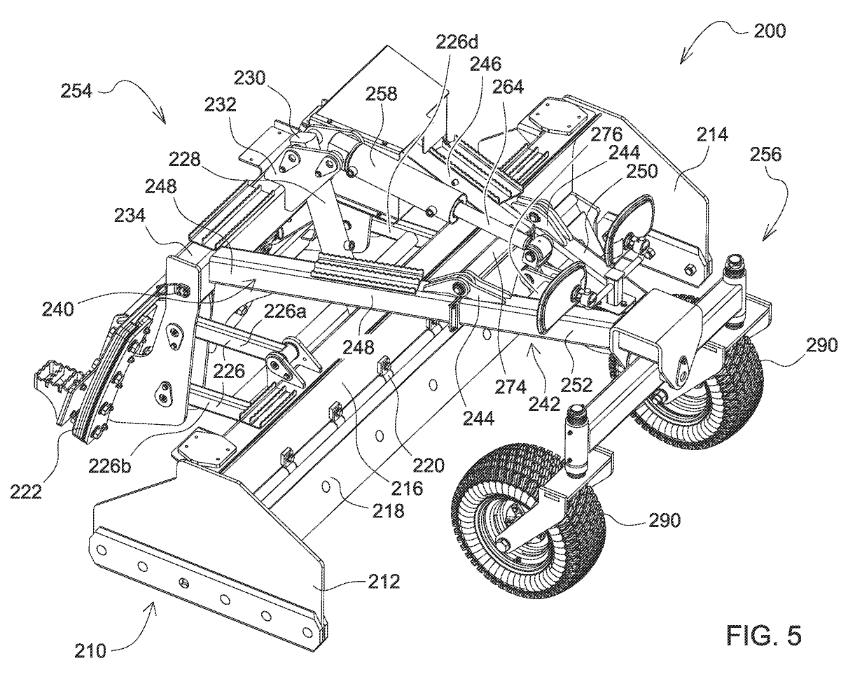

According to one aspect of the present disclosure, a working tool, such as the box blade assembly 200 can be mounted to the working tool mount 128. The box blade assembly 200 can include a box blade, such as box blade 210 shown in FIGS. 1-5. As shown in FIGS. 1 and 5, the box blade 210 comprises a first wall 212 and a second wall 214 separated by a central beam 216. A blade 218 can be mounted to the central beam 216, extending between the first wall 212 and the second wall 214. According to one aspect of the present disclosure, the blade 218 can be mounted to the central beam 216 by blade hinge 220. The blade hinge 220 allows the blade 218 to pivot relative to the central beam 216 in a vertical direction, such that an angle between the blade 218 and the central beam 216 can be freely adjusted. Advantageously, such a configuration may allow the height of the blade 218 relative to the ground to adjust for an uneven ground surface.

According to one aspect of the present disclosure, the box blade assembly 200 can also include a frame member 222. The frame member 222 can include one or more engagement features 224 that are configured to attach the frame member 222 to the mounting plate 132 of the work vehicle 100. In some examples, the one or more engagement features 224 can be bolts that extend through holes in the frame member 222 and corresponding holes in the mounting plate 132 to secure the frame member 222 to the mounting plate 132. In some examples, the one or more engagement features 224 can also include clamps that secure the frame member 222 to the mounting plate 132, which may be used in lieu of or in addition to the bolts. Thus, the frame member 222 (and therefore the box blade assembly 200) can be releasably secured to the mounting plate 132 (and therefore the work vehicle 100).

According to one aspect of the present disclosure, the frame member 222 can include one or more features to accommodate connections between electrical and/or hydraulic devices of the box blade assembly 200 and electrical sources or the hydraulic loop of the work vehicle 100 respectively.

The box blade assembly 200 also comprises one or more arms 226 that extend between the box blade 210 and the frame member 222. The arms 226 can be pivotally connected to the frame member 222 and/or to the box blade 210. In such examples, the elevation and/or pitch of the box blade 210 can be adjusted by pivoting the box blade 210 relative to the one or more arms 226 and/or pivoting the one or more arms 226 relative to the frame member 222. Advantageously, this allows the height of the box blade 210 relative to the ground in order to adjust for an uneven ground surface, and further allows the angle of engagement between the blade 218 and the ground to be adjusted.

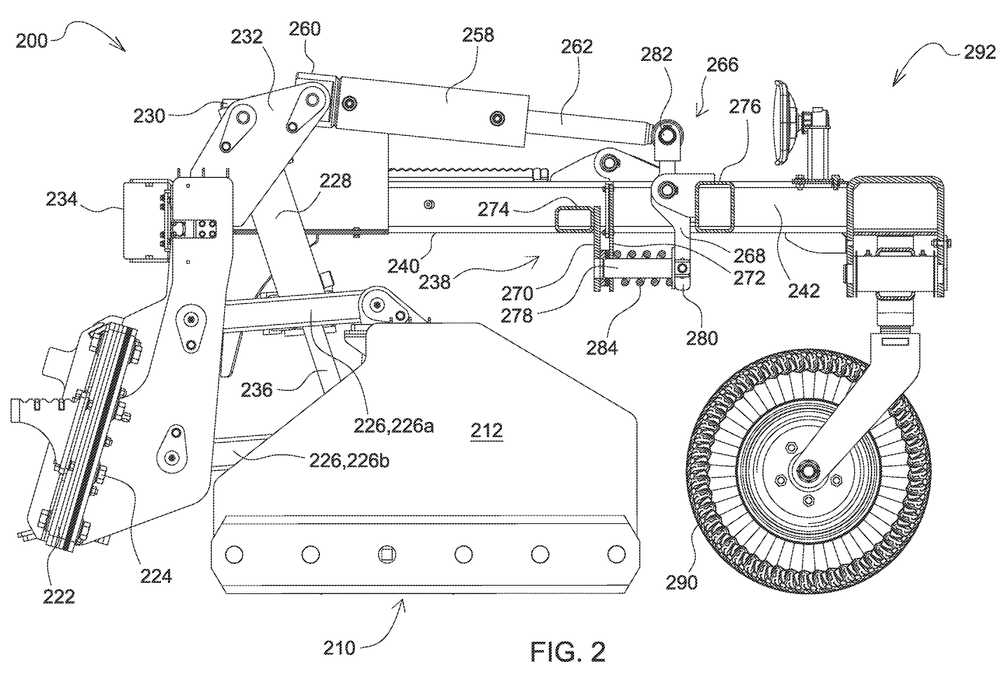

In some examples, such as that shown in FIGS. 2-5, the box blade 210 can be attached to the frame member 222 by two arms 226 positioned on either side of the box blade 210, such that the box blade assembly 200 can include a first left arm 226a, a second left arm 226b positioned below the first left arm 226a, a first right arm 226c (positioned laterally opposite of the first left arm 226a shown in FIGS. 2-5), and a second right arm 226d positioned below the first right arm 226c. This configuration allows two arms (one on each side of the box blade 210) to attach to a top portion of the box blade 210, and two arms (one on each side of the box blade 210) to attach to the bottom portion of the box blade 210. Advantageously in such a condition, the position of the top and bottom of the box blade 210 relative to the frame member 222 can be adjusted independently of one another, which allows for improved control over the pitch of the box blade 210. It is to be understood, however, that while such a configuration is shown in FIGS. 2-5, other configurations of the one or more arms 226 connecting the box blade 210 to the frame member 222 may be used, including configurations with more or fewer one or more arms 226, such as one, two, three, five, or six arms one or more arms 226, and/or alternate positions of any of the one or more arms 226 relative to the box blade 210.

According to one aspect of the present disclosure, the box blade assembly 200 can also include an actuator 228 that extends between the frame member 222 and the box blade 210, as shown in FIGS. 2-5. In some examples, the actuator is connected to the frame member 222 at a first end 230 (sometimes called a proximal end) by an actuator bracket 232, which extends between the proximal end 230 of the actuator 228 and a cross bar 234 of the frame member 222, which extends transverse to the actuator 228. The actuator 228 can be pivotally mounted to the actuator bracket 232, such that the actuator 228 can pivot relative to the actuator bracket 232 (for example, in a forwards or rearwards direction, as shown in FIGS. 2-5. The actuator 228 can be connected at a second end 236 (sometimes called a distal end) to the box blade 210, as shown in FIGS. 2-4. By extending or retracting the actuator 228, the box blade 210 can thereby be raised or lowered. It will be appreciated that, while the actuator 228 can be a hydraulic actuator, such as that shown in FIGS. 2-5, in other examples, the actuator 228 can be another suitable actuator, such as a mechanically driven or pneumatic actuator.

According to one aspect of the disclosure, the box blade assembly 200 can also include a foldable arm 238 extending forwards (that is, in a distal direction) from the frame member 222. As described in greater detail herein, the foldable arm 238 may be part of a foldable hydraulic assembly. The foldable arm 238 is positioned above the box blade 210 and comprises a first segment 240 and a second segment 242. The first segment 240 and the second segment 242 are connected by a pivotal connector 244, which is positioned between the first segment 240 and the second segment 242, so as to allow the foldable arm 238 to move between a folded configuration and an unfolded configuration.

In some examples, when the foldable arm 238 is moved from the unfolded configuration to the folded configuration, the second segment 242 is rotated about the pivotal connector 244 to position it above the first segment 240 (that is, the second segment 242 is moved from a lowered position to a raised position). In some examples, when the foldable arm 238 is moved from the unfolded configuration to the folded configuration, the second segment 242 is rotated about the pivotal connector 244 to position it below the first segment 240 (that is, the second segment 242 is moved from a raised position to a lowered position).

According to one aspect of the present disclosure, such as that illustrated in FIG. 5, each of the first segment 240 and the second segment 242 can comprise a left strut, such that the first segment 240 comprises a first left strut 246 and a first right strut 248, and the second segment 242 comprises a second left strut 250 and a second right strut 252. In such examples, the first left strut 246 and the second left strut 250 are connected by a first pivotal connector 244 and the first right strut 248 and the second right strut 252 are separated by a second pivotal connector 244.

In some examples, the left and right struts of the first segment 240, and the second segment 242 can continuously converge in the distal direction of the first segment 240 and the second segment 242, such that the foldable arm 238 has a substantially triangular shape in the unfolded configuration. Thus, the first left strut 246 and the first right strut 248 are at their most widely spaced at a proximal end 254 of the foldable arm 238, and the second left strut 250 and the second right strut 252 converge at a distal end 256 of the foldable arm 238.

According to one aspect of the present disclosure, the foldable arm 238 can also include an actuator 258. The actuator 258 extends between the second segment 242 of the foldable arm 238 and the frame member 222. Particularly, a first end 260 of the actuator 258 can be connected to the actuator bracket 232 mounted to the cross bar 234 of the frame member 222, and a second end 262 of the actuator 258 can be connected to the second segment 242 of the foldable arm 238. The connections between the actuator 258 and the actuator bracket 232 and second segment 242 can be hinged or pivotal, so as to allow the pivotal motion of the actuator 258 relative to the actuator bracket 232 and/or the second segment 242. Thus, extending or retracting the actuator 258 may fold or unfold the foldable arm 238.

In such examples, the actuator 258 can be movable between an extended position and a retracted position, for example, by extending or retracting a piston 264. Because the actuator 258 is connected to the second segment 242 of the foldable arm 238, extending or retracting the piston 264 can raise or lower the second segment 242 to move the foldable arm 238 between the folded configuration and the unfolded configuration. It will be appreciated that several possible configurations of the actuator 258 and the segments 240, 242 of the foldable arm 238 may achieve this result.

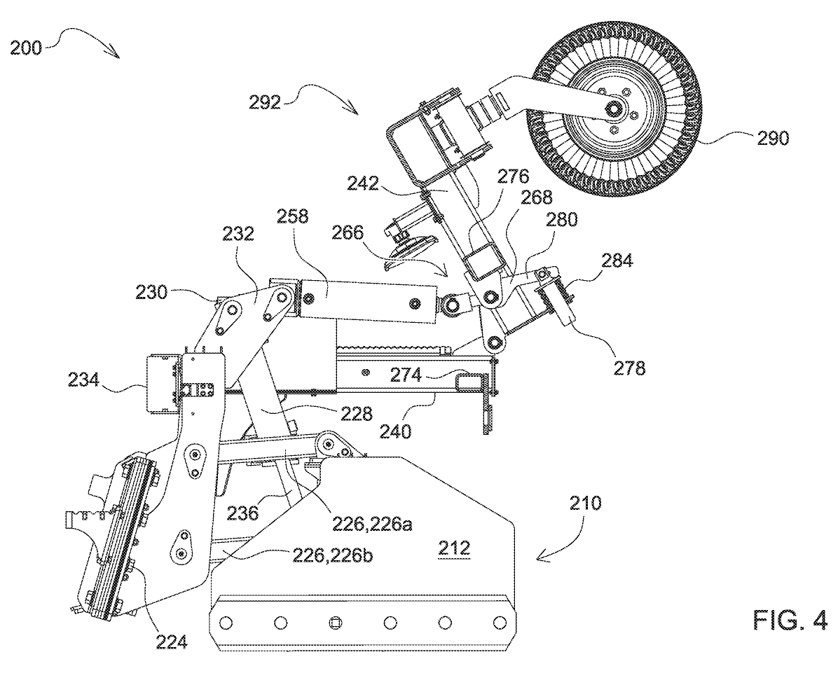

For example, the foldable arm 238 may have a folded configuration that is arrived at by folding the second segment 242 upwards, so that it rests over the first segment 240. In such examples, the extended position of the actuator 258 can correspond to the unfolded configuration, in which the second segment 242 is lowered such that it is aligned with the first segment 240. To move the foldable arm 238 from the unfolded configuration to the folded configuration, the actuator 258 can be moved from the extended position to the retracted position by retracting the piston 264. As the piston 264 is retracted, the second segment 242 is pulled upwards and rearwards, such that it pivots around the pivotal connector(s) 244. When the piston 264 is fully retracted and the actuator 258 is in the retracted position, the second segment 242 will be completely raised and the foldable arm 238 will be in the folded configuration, as shown in FIG. 4. In such examples, the foldable arm 238 can be returned from the folded configuration to the unfolded configuration by returning the actuator 258 to the extended position and lowering the second segment 242 until it is aligned with the first segment 240, as shown in FIG. 2. While in one example, the folded configuration of the foldable arm 238 is arrived at by folding the second segment 242 upwards to position it above the first segment 240, it will be readily appreciated that in alternative examples, the foldable arm 238 can have a folded configuration that is arrived at by folding the second segment 242 below the first segment 240. It will also be appreciated that, while the actuator 258 has been described herein, and shown in FIGS. 2-5, as being positioned above the foldable arm 238, alternative positions of the actuator 258 relative to the foldable arm 238 are possible. For example, the actuator 258 may be positioned below the foldable arm 238 and connect to a lower side of the second segment 242.

According to one aspect of the present disclosure, the actuator 258 can be a hydraulic cylinder. In such examples, the hydraulic actuator 258 can be connected to and driven by a hydraulic loop of the work vehicle 100. It is to be understood, however, that other actuators, such as pneumatic or mechanically driven actuators may also be used in lieu of a hydraulic actuator 258. In such examples, the foldable arm 238 can be called a foldable hydraulic arm.

According to one aspect of the present disclosure, the foldable arm 238 can also include a locking mechanism 266. The locking mechanism 266 is configured to retain or lock the foldable arm 238 in the unfolded configuration and is operationally coupled to the actuator 258 such that when the actuator moves from the retracted position to the extended position, the locking arm moves from the disengaged position to the engaged position. In cases where the foldable arm 238 includes the locking mechanism 266 and a hydraulic actuator 258, the foldable arm 238 may be called a locking hydraulic arm.

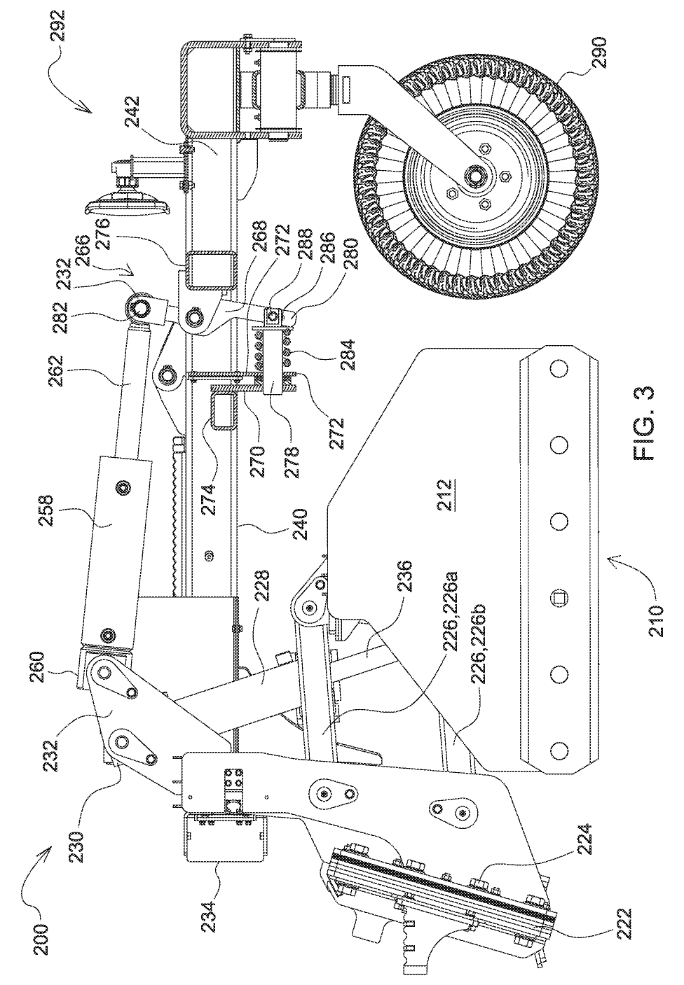

As shown in FIGS. 2-3, the locking mechanism 266 has a locking arm 268. The locking arm 268 can be pivotally mounted to the second segment 242 of the foldable arm 238, such that the locking arm 268 can pivot relative to the second segment 242 to move between an engaged position and a disengaged position. In some examples, a proximal end portion 282 of the locking arm 268 can be attached to a distal end of the actuator 258, such that the actuator can move the locking arm 268 between the engaged position and the disengaged position.

The locking mechanism 266 also comprises one or more brackets mounted to the foldable arm 238. For example, as illustrated in FIGS. 2-5, the locking mechanism 266 comprises a first bracket 270 mounted to the first segment 240, and a second bracket 272 mounted to the second segment 242. In examples where the first segment 240 and the second segment 242 comprise a pair of laterally spaced apart left and right struts, as shown in FIGS. 2-5, the first bracket 270 and the first bracket 270 can be mounted to the respective first and second segments 240, 242 of the foldable arm 238 by one or more cross-bars extending between the left and right struts of the first segment 240 and the second segment 242, such as the first cross-bar 274 and the second cross-bar 276 shown in FIG. 5. The first bracket 270 and the second bracket 272 include apertures configured for receiving a pin or bolt, as described in greater detail herein. According to one aspect of the present disclosure, the apertures in the first bracket 270 and the second bracket 272 are positioned such that the apertures align when the foldable arm 238 is in the unfolded configuration.

According to one aspect of the present disclosure, the locking mechanism 266 also includes a locking bolt 278, as shown in FIGS. 2-4. The locking bolt 278 is attached to a distal end portion 280 of the locking arm 268 and configured to advance or extend through the aligned apertures in the first bracket 270 and the second bracket 272 when the foldable arm 238 is in the unfolded configuration.

According to one aspect of the present disclosure, the locking mechanism 266 may also include a biasing element 284. The biasing element 284 can be configured to return the locking arm 268 from the engaged position to the disengaged position. For example, as shown in FIGS. 2-4, the biasing element 284 can be a spring disposed between the second bracket 272 and the distal end portion 280 of the locking arm 268. In some examples, the biasing element 284 can be disposed around the locking bolt 278. When the locking arm 268 is moved from the disengaged position to the engaged position, the biasing element 284 is compressed between the distal end portion 280 of the locking arm 268 and the second bracket 272. Thus, the biasing element 284 applies a resistive force to the distal end portion 280 of the locking arm 268, which is opposed by a force exerted by the actuator 258 on the proximal end portion 282 of the locking arm 268, such that when the force exerted by the actuator 258 is removed from the locking arm 268, the force exerted by the biasing element 284 returns the locking arm 268 from the engaged position to the disengaged position.

According to one aspect of the present disclosure, the distal end portion of the locking arm 268 comprises a groove 286, as shown in FIG. 3. In such examples, the locking bolt 278 may be attached to the locking arm 268 by a pin 288 that extends through the groove to movably couple the locking bolt 278 to the locking arm 268. Advantageously, this movable connection between the locking bolt 278 and the locking arm 268 may assist in keeping the locking bolt 278 straight as the locking mechanism 266 moves from the disengaged position to the engaged position.

Advantageously, the locking mechanism 266 secures the foldable arm 238 in a substantially static condition. More particularly, because the locking mechanism 266 locks the second segment 242 relative to the first segment 240, and because the second segment 242 is connected to the actuator 258, when the locking mechanism 266 is engaged, the actuator 258 is prevented from drifting towards the retracted position. This may be particularly advantageous when the actuator 258 is a hydraulic actuator, because hydraulic actuators may drift from an extended position towards a retracted position. However, if the second segment 242 of the foldable arm 238 is secured in place by the locking mechanism 266, the second end 262 of the actuator 258 is also secured in place, which reduces or prevents linear drift of the hydraulic actuator 258. Because the position of the second segment 242 relative to the first segment 240 depends in part on the linear position of the actuator 258, linear drift of the actuator 258 may cause the position of the second segment 242 relative to the first segment 240 to similarly change. Accordingly, the angle between the second segment 242 and the first segment 240 can change, which may in turn affect an angle between the box blade 210 and the ground. Thus, the locking mechanism 266 may advantageously prevent undesired changes in the relative position of the second segment 242 and the first segment 240, and thus the angle between the box blade 210 and the ground.

It will be particularly appreciated that, because deviations in the angle between the box blade 210 and the ground can be larger than the desired finish of a grade produced by the box blade 210 in some examples, the inclusion of the locking mechanism 266 may allow for the box blade assembly 200 to be used to produce grades of finer finish than would be possible in the absence of the locking mechanism 266.

According to one aspect of the present disclosure, the locking mechanism 266 can be configured such that the movement of the actuator 258 engages and disengages the one or more arms 226. For example, as shown in FIG. 4, when the actuator 258 is in the retracted position and the foldable arm 238 is in the folded configuration, the locking mechanism 266 is in the disengaged position. In the disengaged position, the locking bolt 278 may extend only through the second bracket 272.

As the actuator 258 moves from the retracted position to the extended position, the second segment 242 pivots rotationally relative to the first segment 240 and lowers until the second segment 242 is aligned with the first segment 240, as shown in FIG. 2. In some examples, when the actuator 258 is in the extended position, the locking mechanism 266 may not be in the engaged position (that is, the locking bolt 278 may still extend only through the second bracket 272).

The actuator 258 can then extend further from the extended position to the locked position, as shown in FIG. 3. As the actuator 258 moves from the extended position to the locked position, the piston 264 engages the proximal end portion 282 of the locking arm 268 and moves the locking mechanism 266 from the disengaged position to the engaged position. As the locking mechanism 266 moves from the disengaged position to the engaged position, the locking bolt 278 is introduced through the aperture in the first bracket 270, thereby securing the first bracket 270 against the second bracket 272 and locking the foldable arm 238 in the unfolded configuration.

To return the foldable arm 238 to the folded position, the actuator 258 is withdrawn from the locked position to the extended position. This relieves the force of the piston 264 against the proximal end portion 282 of the locking arm 268 and allows the biasing element 284 to return the locking mechanism 266 from the engaged position to the disengaged position.

As the actuator 258 is withdrawn further from the extended position to the retracted position, the actuator 258 pulls the second segment 242 of the foldable arm 238 rearwards and upwards, such that the second bracket second segment 242 pivots around the pivotal connector 244 relative to the first segment 240. Thus, the foldable arm 238 can be returned to the folded configuration.

According to one aspect of the present disclosure, the box blade assembly 200 can also include one or more ground engaging features 290, which can be disposed at a distal end portion 292 of the foldable arm 238, as shown in FIGS. 2-5. In some examples, the ground engaging feature 290 can be one or more wheels, which support the distal end portion 292 of the foldable arm 238, and therefore the box blade assembly 200, against the ground. In the specific example illustrated in FIG. 5, the ground engaging feature 290 can comprise two wheels spaced laterally apart from one another towards a left and right side of the box blade assembly 200, respectively. It will be appreciated, however, that in other examples, the ground engaging feature 290 may include a different number of wheels, such as 1, 3, 4, or more than 4 wheels. It will also be understood that other devices may make up the ground engaging feature 290, including tracks, rails, or skids.

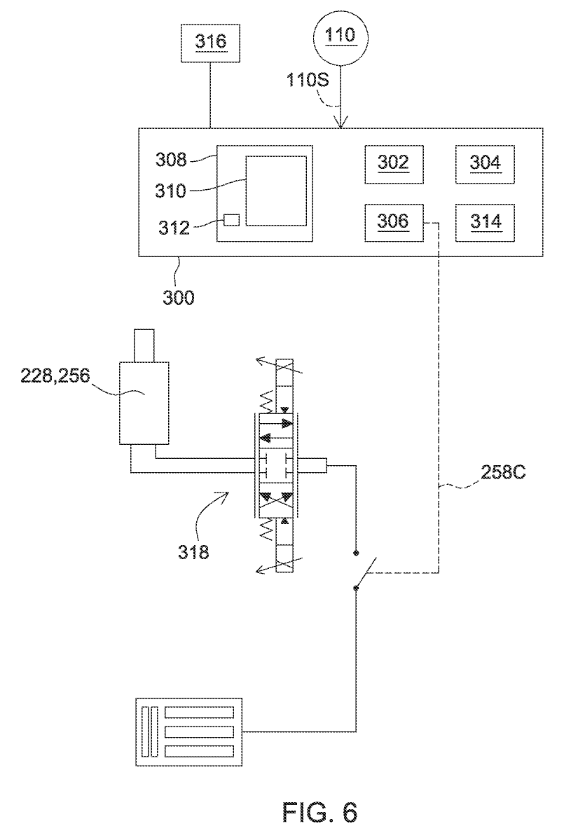

The box blade assembly 200 can also be in communication with a controller, such as the controller 300 shown in FIG. 6. The controller 300 can be configured for the computerized operation, either automatic or partially automated, of the box blade assembly 200.

The controller 300 includes or may be associated with a processor 302, a computer readable medium 304, a database 306 and an input/output module or control panel 308 having a display 310. The control panel 308 may be a part of the control station 110 in the operator cab 140. An input/output device 312, such as a keyboard, joystick or other user interface, can be provided so that a human operator may input instructions to the controller 300. It is understood that the controller 300 described herein may be a single controller having the described functionality, or it may include multiple controllers wherein the described functionality is distributed among the multiple controllers. Some or all of the controllers may be located at a location other than the work vehicle and be connected wirelessly.

Various operations, steps or algorithms as described in connection with the controller 300 can be embodied directly in hardware, in a computer program product 314 such as a software module executed by the processor 302, or in a combination of the two. The computer program product 314 can reside in RAM memory, flash memory, ROM memory, EPROM memory, EEPROM memory, registers, hard disk, a removable disk, or any other form of computer-readable medium 304 known in the art. An exemplary computer-readable medium 304 can be coupled to the processor 302 such that the processor 302 can read information from, and write information to, the memory/ storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

According to one aspect of the present disclosure, illustrated in FIG. 3, the controller 300 is configured to receive one or more input signals and to produce and transmit one or more output signals in response to or based in part on the input signals.

Particularly, a user interface 316 can be associated with the controller 300. The user interface 316 may be associated with the control station 110 of the work vehicle 100, previously described, or with a separate device, such as a mobile device, so that a user or a remote user can enter user input such as one or more signals to the controller 300 through the user interface 316. For example, the user or remote user can enter an actuator input signal 110S, which can direct the controller to issue an actuator control signal 258C to one or more hydraulic valves which control the actuators of the box blade assembly 200 (for example, the actuator 228 and the actuator 258 previously described.

For example, when the actuator 228 and the actuator 258 are hydraulic actuators, the actuator control signal 258C can cause one or more hydraulic valves 318 in communication with the controller 300 to move between an first, second, and third position, wherein when the valve(s) 318 are in the first configuration the hydraulic actuators 228, 258 are extended, when the valve(s) 318 are in the second configuration the hydraulic actuators 228, 258 are held in a constant position, and when the valve(s) 318 are in the third configuration the hydraulic actuators 228, 258 are retracted.

In this way, the extension and retraction of the actuators can be controlled by a user with access to the user interface 316. This allows the position and/or configuration of the box blade 210 and the foldable arm 238 to be adjusted by driving the actuators using one or more remote signals. For example, if the controller 300 is in communication with the actuator 258, one or more user input signals 110S can be transmitted from the control station 110 to the controller 300, which can generate one or more corresponding actuator control signals 258C. The one or more actuator control signals 258C can cause the actuator to extend from the retracted position to the extended position, or from the extended position to the locked position, or retracted from the locked position to the extended position, or from the extended position to the retracted position. Advantageously, this allows a user to control the position of the box blade 210 and/or the configuration of the foldable arm 238 from within the operator cab 140.

Additionally, since the locking mechanism 266 can be connected to the actuator 258 as previously described, the locking mechanism can be engaged and disengaged by adjusting the configuration of the actuator 258. Because the actuator 258 can be controlled from within the operator cab 140 by one or more commands input by a user to the user interface 316, this allows the locking mechanism to be engaged or disengaged from within the operator cab 140.

Thus, although there have been described particular embodiments of the present invention of a new and useful FOLDABLE ASSEMBLY it is not intended that such references be construed as limitations upon the scope of this invention except as set forth in the following claims.

What is claimed is:

1. A box blade assembly for a work vehicle, the box blade assembly comprising:
a frame member;
a box blade extending from the frame member;
a foldable arm extending from the frame member and positioned above the box blade, the foldable arm having a first segment mounted to the frame member at a proximal end of the first segment, a second segment extending from a distal end of the first segment, and a pivotal connector positioned between the first segment and the second segment, so as to allow the foldable arm to move between a folded configuration and an unfolded configuration;
an actuator extending between the first segment and the second segment of the foldable arm and movable between an extended position and a retracted position;
wherein moving the actuator between extended position and the retracted position folds or unfolds the foldable arm.

2. The box blade assembly of claim 1, further comprising a locking mechanism configured to lock the foldable arm in the unfolded configuration.

3. The box blade assembly of claim 2, wherein locking mechanism is engaged by the actuator when the actuator moves from the retracted position to the extended position.

4. The box blade assembly of claim 2, wherein the locking mechanism comprises:
a first bracket mounted to the first segment of the foldable arm and including a first aperture;
a second bracket mounted to the second segment of the foldable arm and including a second aperture;
a locking arm pivotally mounted to the second segment of the foldable arm and movable between an engaged position and a disengaged position;
a locking bolt coupled to a distal end portion of the locking arm;
wherein the first aperture and the second aperture are configured to receive the locking bolt, and wherein moving the locking arm from the disengaged position to the engaged position introduces the locking bolt into the first aperture.

5. The box blade assembly of claim 4, wherein the locking arm is operationally coupled to the actuator, such that when the actuator moves from the retracted position to the extended position, the locking arm moves from the disengaged position to the engaged position.

6. The box blade assembly of claim 5, wherein the actuator is coupled to the second segment of the foldable arm by the locking arm, which extends between the actuator and the second segment of the foldable arm.

7. The box blade assembly of claim 4, wherein the locking mechanism further comprises a biasing element disposed between the distal end portion of the locking arm and the second bracket and configured to return the locking arm from the engaged position to the disengaged position.

8. The box blade assembly of claim 7, wherein the biasing element is a spring disposed around the locking bolt.

9. The box blade assembly of claim 7, wherein a distal end portion of the locking arm comprises a groove, and a proximal end portion of the locking bolt comprises a pin that extends through the groove to movably couple the locking bolt to the locking arm.

10. The box blade assembly of claim 1, wherein the actuator is a hydraulic cylinder.

11. The box blade assembly of claim 1, further comprising a controller configured to control the actuator in response to a user input to move the actuator from the extended position to the retracted position or from the retracted position to the extended position.

12. The box blade assembly of claim 11, wherein the controller comprises a user interface that receives the user input from a remote user.

13. The box blade assembly of claim 1, wherein when the actuator moves from the retracted position to the extended position, the second segment of the foldable arm pivots around the pivotal connector from a raised position to a lowered position.

14. The box blade assembly of claim 1, further comprising one or more ground engaging features attached to a distal end portion of the second segment of the foldable arm.

15. A work vehicle comprising the box blade assembly of claim 1.

16. A foldable hydraulic assembly, comprising:
a foldable arm having a first segment, a second segment, and a pivotal connector connecting the first segment to the second segment such that the second segment is movable between a folded configuration and an unfolded configuration;
a hydraulic cylinder extending between the first segment and the second segment of the foldable arm and configured to move between a retracted position, an extended position, and a locked position;
a ground engaging feature attached to an end portion of the second segment of the foldable arm opposite to the pivotal connector; and
a locking mechanism operatively coupled to the hydraulic cylinder and configured to move between a disengaged position and an engaged position;
wherein moving the hydraulic cylinder from the retracted position to the extended position moves the foldable arm from the folded configuration to the unfolded configuration,
wherein moving the hydraulic cylinder from the extended position to the locked position moves the locking mechanism from the disengaged position to the engaged position, and
wherein when the locking mechanism is in the engaged position, the second segment of the foldable arm is fixed relative to the first segment of the foldable arm.

17. The foldable hydraulic assembly of claim 16, wherein the locking mechanism comprises:
a bracket mounted to the first segment of the foldable arm and including an aperture;
a locking arm pivotally mounted to the second segment of the foldable arm and connected to a distal end portion of the hydraulic cylinder;
a locking bolt connected to a distal end portion of the locking arm,
wherein when the locking mechanism is in the engaged position, the locking bolt extends through the aperture of the bracket.

18. The foldable hydraulic assembly of claim 16, further comprising a controller in configured to control the operation of the hydraulic cylinder in response to a user input, wherein the controller generates a control signal to move the hydraulic cylinder between the retracted position, the extended position, and the locked position.

19. A method for remotely deploying a locking hydraulic arm of a work vehicle, the method comprising:
transmitting a control signal to drive a hydraulic cylinder;
extending the hydraulic cylinder from a retracted position to an extended position in response to the control signal to move the locking hydraulic arm from a folded configuration to an unfolded configuration;
engaging a locking mechanism to prevent the locking hydraulic arm from returning to the folded configuration from the unfolded configuration,
wherein the locking mechanism is operatively connected to the hydraulic cylinder, such that locking mechanism is automatically engaged by the extending of the hydraulic cylinder after the locking hydraulic arm reaches the unfolded configuration.

20. The method of claim 19, further comprising:
retracting the hydraulic cylinder from the extended position to the retracted position to disengage the locking mechanism and move the locking hydraulic arm from the unfolded configuration to the folded configuration.
